(19) United States
(12) Patent Application Publication
(10) Pub. No.: US 2022/0335489 A1
(43) Pub. Date: Oct. 20, 2022

(54) CLUSTERING ITEMS OFFERED BY AN ONLINE CONCIERGE SYSTEM TO CREATE AND TO RECOMMEND COLLECTIONS OF ITEMS TO USERS

(71) Applicant: Maplebear, Inc.(dba Instacart), San Francisco, CA (US)

(72) Inventors: Sharath Rao Karikurve, San Francisco, CA (US); Angadh Singh, Dublin, CA (US)

(21) Appl. No.: 17/232,621

(22) Filed: Apr. 16, 2021

(51) Int. Cl. G06Q 30/06; G06N 20/00; G06F 17/16

(52) U.S. Cl. CPC G06Q 30/0603; G06N 20/00; G06F 17/16

(57) ABSTRACT

An online concierge system maintains information about items offered for purchase and users of the online concierge system. Based on prior purchases of items by users, the online concierge system trains a model to determine a likelihood of a user purchasing an item based on an embedding for the object and embedding for the user. The online concierge system identifies a collection of items and generates an embedding for the collection. The collection may be a cluster of items determined from similarities between embeddings of items. Alternatively, the collection may be a group of items having a common category. The online concierge system includes one or more collections of items along with individual items when recommending items for the users, so the trained model is applied to embeddings of the individual items and to embeddings of the one or more collections to generate recommendations for a user.

### BACKGROUND

This disclosure relates generally to ordering an item through an online concierge system, and more specifically to recommending collections of items to a user of the online concierge system.

In current online concierge systems, shoppers (or “pickers”) fulfill orders at a physical warehouse, such as a retailer, on behalf of users as part of an online shopping concierge service. An online concierge system provides an interface to a user identifying items offered by a physical warehouse and receives selections of one or more items for an order from the user. In current online concierge systems, the shoppers may be sent to various warehouses with instructions to fulfill orders for items, and the shoppers then find the items included in the user order in a warehouse.

Many online concierge systems maintain a large inventory of items. For example, an online concierge system communicating with multiple warehouses may maintain a catalog of tens or hundreds of thousand items, if not more. While such an inventory provides users of the online concierge system with a wide selection of products, maintaining a large inventory of items makes it difficult for the online concierge system to preemptively identify items to users that are likely to satisfy a user's preferences. While many online concierge systems provide search interfaces allowing users to identify items from an online concierge system's inventory, using search terms from a user relies on an online concierge system user identifying items or attributes of items for the online concierge system to identify items for the user. This allows users to identify specific items but limits an ability of the online concierge system to prospectively identify items to users that are likely to be of interest to the users before receiving search terms or requests for items or attributes of items.

### SUMMARY

When a user is identifying items from a warehouse for inclusion in an order via an online concierge system, the user often provides search queries from the user through an interface. The search query includes one or more search terms for identifying one or more items the user seeks to purchase via the online concierge system. The online concierge system identifies items having attributes matching or similar to one or more of the search terms, allowing the user to select items for inclusion in the order. While this allows the user to identify specific items, use of search terms to identify items to a user limits the ability of the online concierge system to prospectively identify items to the user that the user is likely to purchase, which may increase a number of orders or a number of items in orders received from the user.

To allow the online concierge system to identify items that a user is likely to purchase to the user, the online concierge system obtains an inventory of items offered by one or more warehouses. In some embodiments, the online concierge system obtains an inventory from each warehouse, with an inventory from a warehouse identifying items offered by the warehouse. The inventory includes different entries, with each entry including information identifying an item (e.g., an item identifier, an item name) and one or more attributes of the item. Example attributes of an item include: one or more keywords, a brand offering the item, a manufacturer of the item, a type of the item, a price of the item, a quantity of the item, a size of the item and any other suitable information. Additionally, one or more attributes of an item may be specified by the online concierge system for the item and included in the entry for the item in the inventory. Example attributes specified by the online concierge system 102 for an item include: a category for the item, one or more sub-categories for the item, and any other suitable information for the item.

From the information about various items in the inventory and information stored by the online concierge system describing prior interactions by users of the online concierge system selecting items, the online concierge system generates an embedding for each item. In some embodiments, the embedding for an item includes dimensions corresponding to different words or phrases received by the online concierge system as terms from users in interactions where the user selected the item. Each dimension may include a value corresponding to a frequency with which the word or phrase corresponding to the dimension was received by the online concierge system in interactions where a user selected the item. One or more of the dimensions of the embedding correspond to categories associated with the item by the online concierge system, such as a department within a warehouse including an item. When determining values of dimensions of embeddings for an item, the online concierge system may evaluate interactions in which items were selected by users that occurred within a specified time interval (e.g., within 180 days of a current date). Alternatively or additionally, the online concierge system orders items by dates when a user purchased or selected the items and generates embeddings for items having at least a threshold position in the ordering, allowing generation of the embeddings for more recently purchased or selected items. To generate the embedding for an item, the online concierge system applies an item model to attributes of the item, with the item model outputting the embedding for the item from the attributes of the item.

Additionally, the online concierge system generates one or more collections of items offered by a warehouse. In some embodiments, the online concierge system selects items offered by the warehouse that have one or more common attributes for the collection. For example, a collection includes items offered by the warehouse that are each associated with a common category by the online concierge system. As another example, a collection includes one or more items each associated with a common keyword by the online concierge system or by the warehouse. In other embodiments, the online concierge system generates a collection based on embeddings for items offered by the warehouse. For example, the online concierge system generates a collection by clustering items offered by the warehouse based on the embeddings for the items. In one embodiment, K-means clustering is used to cluster items offered by the warehouse based on embeddings for the various items. Using K-means clustering causes an item to be clustered based on the distance of each dimension of an embedding for the item to a mean value associated with a dimension across all embeddings. For example, items having a value associated with a dimension that is within a specified distance to a mean value associated with the dimension are included in a cluster. The online concierge system generates a collection as including items in a cluster. However, in other embodiments, the online concierge system 102 may use any suitable method or methods to generate clusters of items based on their corresponding embeddings, with the clusters of items specifying collections of items.

In some embodiments, the online concierge system leverages stored information about prior purchases by users to generate a cluster. For example, the online concierge system retrieves information describing purchases by one or more users and identifies items that co-occur in at least a threshold number or at least a threshold percentage of the prior purchases, the identified items are included in a cluster by the online concierge system. In some embodiments, the online concierge system identifies items that co-occurred in prior purchases from a specific user or that co-occurred in prior purchases from users having one or more common characteristics. Additionally, the online concierge system may identify prior purchases occurring within a specific time interval to identify items co-occurring in orders for inclusion in a cluster.

Using the embeddings for various items in a collection, the online concierge system generates a collection embedding for the cluster. For example, a collection embedding is generated for each collection generated by the online concierge system based on the embeddings corresponding to each item in a collection. In some embodiments, the collection embedding is generated by averaging values of dimensions of embeddings for items included in the collection. The online concierge system may weight one or more dimensions of embeddings based on any suitable criteria and generate the collection embedding based on the weighted values of dimensions of items in the collection. The online concierge system stores an identifier of a collection of items along with identifiers of items in the collection and the collection embedding generated for the collection.

In addition to generating embeddings for items and collection embeddings for one or more collections of items, the online concierge system identifies a user of the online concierge system and generates an embedding for the user. For example, the online concierge system identifies a user from whom a request for one or more items was received and generates the embedding for the user. As another example, the online concierge system generates an embedding for a user who is currently accessing the online concierge system.

To generate the embedding for the user, the online concierge system identifies items selected or purchased by the user and retrieves embeddings for the identified items. In some embodiments, the online concierge system identifies items that the user purchased within a particular time interval (e.g., within 180 days of a current date), retrieves embeddings for the identified items, and generates an embedding for the user with different dimensions corresponding to different products and values of the dimensions based on frequencies with which the user purchased products corresponding to the dimensions. In various embodiments, the online concierge system averages values of the dimensions based on a number of purchases by the user and generates the embedding for the user from the average values of the dimensions. Additionally, one or more dimensions of the embedding for the user correspond to characteristics of the user maintained by the online concierge system. Example dimensions of the embedding for the user correspond to one or more dietary preferences or restrictions of the user, frequency of purchases from the warehouse by the user, and any other suitable information maintained by the online concierge system. A user model maintained by the online concierge system is applied to characteristics of the user to generate the embedding for the user.

The online concierge system applies a trained purchase model to the embedding for the user and to embeddings for one or more items. The purchase model is trained based on items purchased by users, as well as items available to be purchased that were not purchased by users. From an input of the embedding for the user from the user model and an embedding for an item from the item model, the trained purchase model outputs a probability of the user purchasing the item. The embedding for the user from the user model and embeddings for the items from the item model have an equal number of dimensions in various embodiments, with the trained purchase model determining the probability of the user purchasing an item based on a dot product of the embedding for the user and the embedding for the item, or based on another suitable measure of similarity between the embedding of the item and the embedding of the user. In various embodiments, the probability of the user purchasing in item is directly related to the dot product of the embedding for the user and the embedding for the item.

The online concierge system also applies the trained purchase model to the collection embedding and the embedding for the user, generating a probability of the user purchasing one or more items in the collection. As the collection includes one or more items, application of the trained purchase model to the collection embedding and the embedding for the user allows the online concierge system to determine a probability of the user purchasing one or more items within the collection, enabling the online concierge system to more efficiently determine if items in the collection are likely to be of interest to the user.

When the online concierge system receives a request for content from the user, the online concierge system generates an interface displaying various items based on the probabilities of the user purchasing different items determined from application of the trained model to the embedding for the user and embeddings for various items. Additionally, the interface includes information identifying one or more collections based on the probabilities of the user purchasing one or more items in a collection from application of the trained model to the embedding for the user and to collection embeddings for one or more collections. The interface displays information identifying items and one or more collections in an order based on the corresponding probabilities of the user purchasing items or purchasing an item from a collection. For example, the online concierge system ranks items and one more collections based on the probabilities of the user purchasing items, or purchasing an item from a collection, with items or collections with higher probabilities having higher positions in the ranking. The interface orders the items and the one or more collections based on the ranking and displays the items and the one or more collections according to the order. This allows the interface to identify items to the user that accounts for the user's probability of purchasing different products or of purchasing one or more items within a collection of items, allowing the online concierge system to more readily identify items or collections of items to the user that the user is likely to purchase.

### BRIEF DESCRIPTION OF THE DRAWINGS

FIG. 1 illustrates an environment of an online shopping concierge service, according to one embodiment.

FIG. 2 is a diagram of an online shopping concierge system, according to one embodiment.

FIG. 3A is a diagram of a customer mobile application (CMA), according to one embodiment.

FIG. 3B is a diagram of a shopper mobile application (SMA), according to one embodiment.

FIG. 4 is a flowchart of a process for predicting inventory availability, according to one embodiment.

FIG. 5 is a flowchart of a process for training a purchase model generating a probability of a user purchasing an item, according to one embodiment.

FIG. 6 is a flowchart of a method determining a probability of a user purchasing an item or a collection of items, according to one embodiment.

FIG. 7 is a process flow diagram a purchase model determining a probability of a user purchasing an item, in accordance with an embodiment.

The figures depict embodiments of the present disclosure for purposes of illustration only. One skilled in the art will readily recognize from the following description that alternative embodiments of the structures and methods illustrated herein may be employed without departing from the principles, or benefits touted, of the disclosure described herein.

### DETAILED DESCRIPTION

### System Overview

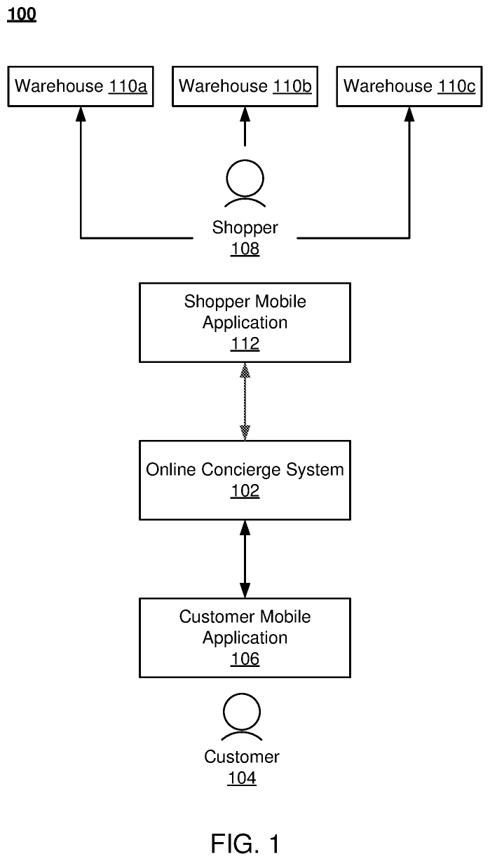

FIG. 1 illustrates an environment 100 of an online platform, according to one embodiment. The figures use like reference numerals to identify like elements. A letter after a reference numeral, such as “110a,” indicates that the text refers specifically to the element having that particular reference numeral. A reference numeral in the text without a following letter, such as “110,” refers to any or all of the elements in the figures bearing that reference numeral. For example, “110” in the text refers to reference numerals “110a” and/or “110b” in the figures.

The environment 100 includes an online concierge system 102. The system 102 is configured to receive orders from one or more users 104 (only one is shown for the sake of simplicity). An order specifies a list of goods (items or products) to be delivered to the user 104. The order also specifies the location to which the goods are to be delivered, and a time window during which the goods should be delivered. In some embodiments, the order specifies one or more retailers from which the selected items should be purchased. The user may use a customer mobile application (CMA) 106 to place the order; the CMA 106 is configured to communicate with the online concierge system 102.

The online concierge system 102 is configured to transmit orders received from users 104 to one or more shoppers 108. A shopper 108 may be a contractor, employee, other person (or entity), robot, or other autonomous device enabled to fulfill orders received by the online concierge system 102. The shopper 108 travels between a warehouse and a delivery location (e.g., the user's home or office). A shopper 108 may travel by car, truck, bicycle, scooter, foot, or other mode of transportation. In some embodiments, the delivery may be partially or fully automated, e.g., using a self-driving car. The environment 100 also includes three warehouses 110a, 110b, and 110c (only three are shown for the sake of simplicity; the environment could include hundreds of warehouses). The warehouses 110 may be physical retailers, such as grocery stores, discount stores, department stores, etc., or non-public warehouses storing items that can be collected and delivered to users. Each shopper 108 fulfills an order received from the online concierge system 102 at one or more warehouses 110, delivers the order to the user 104, or performs both fulfillment and delivery. In one embodiment, shoppers 108 make use of a shopper mobile application 112 which is configured to interact with the online concierge system 102.

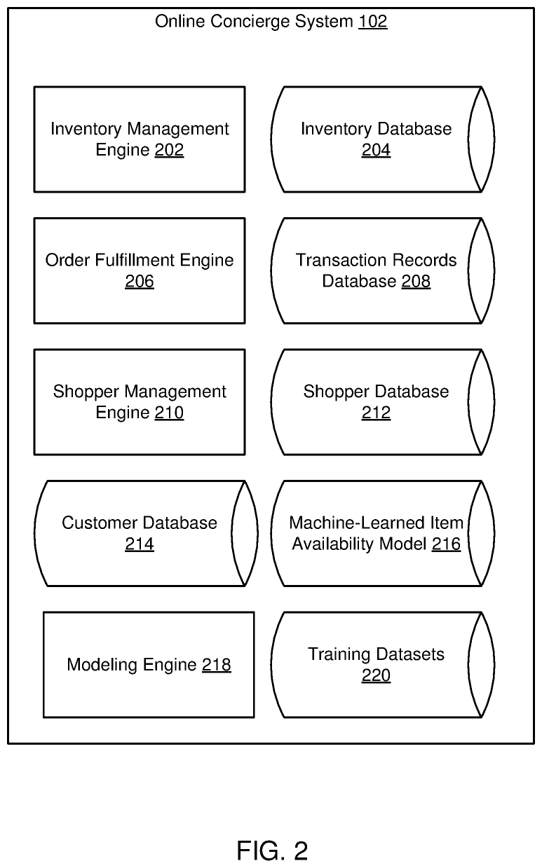

FIG. 2 is a diagram of an online concierge system 102, according to one embodiment. The online concierge system 102 includes an inventory management engine 202, which interacts with inventory systems associated with each warehouse 110. In one embodiment, the inventory management engine 202 requests and receives inventory information maintained by the warehouse 110. The inventory of each warehouse 110 is unique and may change over time. The inventory management engine 202 monitors changes in inventory for each participating warehouse 110. The inventory management engine 202 is also configured to store inventory records in an inventory database 204. The inventory database 204 may store information in separate records—one for each participating warehouse 110—or may consolidate or combine inventory information into a unified record. Inventory information includes both qualitative and qualitative information about items, including size, color, weight, SKU, serial number, and so on. In one embodiment, the inventory database 204 also stores purchasing rules associated with each item, if they exist. For example, age-restricted items such as alcohol and tobacco are flagged accordingly in the inventory database 204. Additional inventory information useful for predicting the availability of items may also be stored in the inventory database 204. For example, for each item-warehouse combination (a particular item at a particular warehouse), the inventory database 204 may store a time that the item was last found, a time that the item was last not found (a shopper looked for the item but could not find it), the rate at which the item is found, and the popularity of the item.

Inventory information provided by the inventory management engine 202 may supplement the training datasets 220. Inventory information provided by the inventory management engine 202 may not necessarily include information about the outcome of picking a delivery order associated with the item, whereas the data within the training datasets 220 is structured to include an outcome of picking a delivery order (e.g., if the item in an order was picked or not picked).

The online concierge system 102 also includes an order fulfillment engine 206 which is configured to synthesize and display an ordering interface to each user 104 (for example, via the customer mobile application 106). The order fulfillment engine 206 is also configured to access the inventory database 204 in order to determine which products are available at which warehouse 110. The order fulfillment engine 206 may supplement the product availability information from the inventory database 204 with an item availability predicted by the machine-learned item availability model 216. The order fulfillment engine 206 determines a sale price for each item ordered by a user 104. Prices set by the order fulfillment engine 206 may or may not be identical to in-store prices determined by retailers (which is the price that users 104 and shoppers 108 would pay at the retail warehouses). The order fulfillment engine 206 also facilitates transactions associated with each order. In one embodiment, the order fulfillment engine 206 charges a payment instrument associated with a user 104 when he/she places an order. The order fulfillment engine 206 may transmit payment information to an external payment gateway or payment processor. The order fulfillment engine 206 stores payment and transactional information associated with each order in a transaction records database 208.

In some embodiments, the order fulfillment engine 206 also shares order details with warehouses 110. For example, after successful fulfillment of an order, the order fulfillment engine 206 may transmit a summary of the order to the appropriate warehouses 110. The summary may indicate the items purchased, the total value of the items, and in some cases, an identity of the shopper 108 and user 104 associated with the transaction. In one embodiment, the order fulfillment engine 206 pushes transaction and/or order details asynchronously to retailer systems. This may be accomplished via use of webhooks, which enable programmatic or system-driven transmission of information between web applications. In another embodiment, retailer systems may be configured to periodically poll the order fulfillment engine 206, which provides detail of all orders which have been processed since the last request.

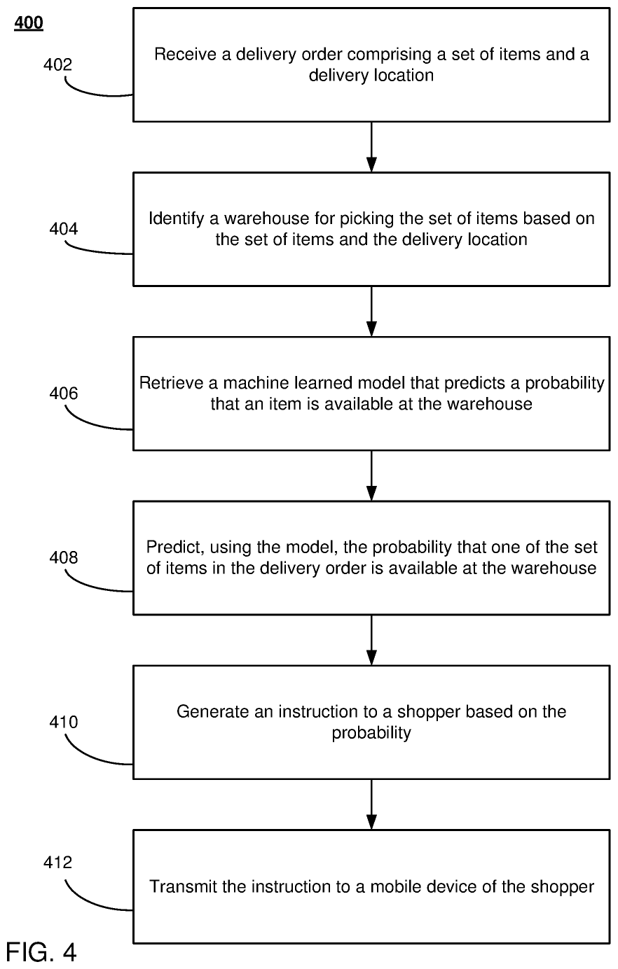

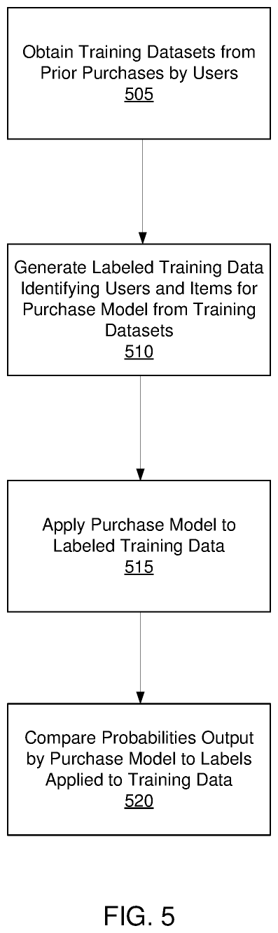

The order fulfillment engine 206 may interact with a shopper management engine 210, which manages communication with and utilization of shoppers 108. In one embodiment, the shopper management engine 210 receives a new order from the order fulfillment engine 206. The shopper management engine 210 identifies the appropriate warehouse to fulfill the order based on one or more parameters, such as a probability of item availability determined by a machine-learned item availability model 216, the contents of the order, the inventory of the warehouses, and the proximity to the delivery location. The shopper management engine 210 then identifies one or more appropriate shoppers 108 to fulfill the order based on one or more parameters, such as the shoppers' proximity to the appropriate warehouse 110 (and/or to the user 104), his/her familiarity level with that particular warehouse 110, and so on. Additionally, the shopper management engine 210 accesses a shopper database 212 which stores information describing each shopper 108, such as his/her name, gender, rating, previous shopping history, and so on. Methods that can be used to identify a warehouse 110 at which a shopper 108 can likely find most or all items in an order are described with respect to FIGS. 4 and 5.

As part of fulfilling an order, the order fulfillment engine 206 and/or shopper management engine 210 may access a user database 214 which stores information describing each user. This information could include each user's name, address, gender, shopping preferences, favorite items, stored payment instruments, and so on.

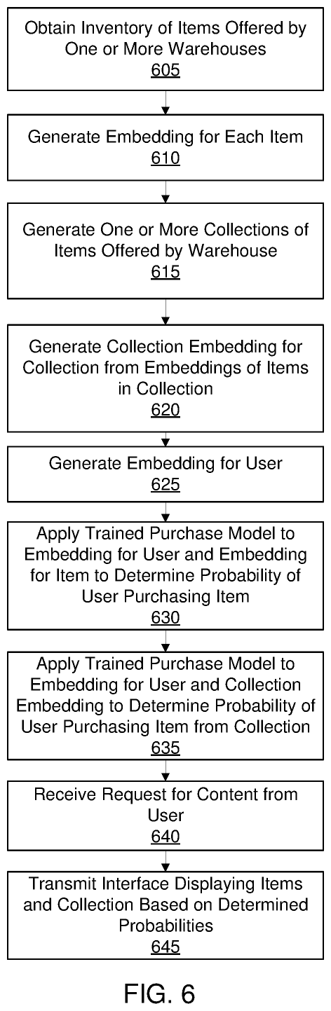

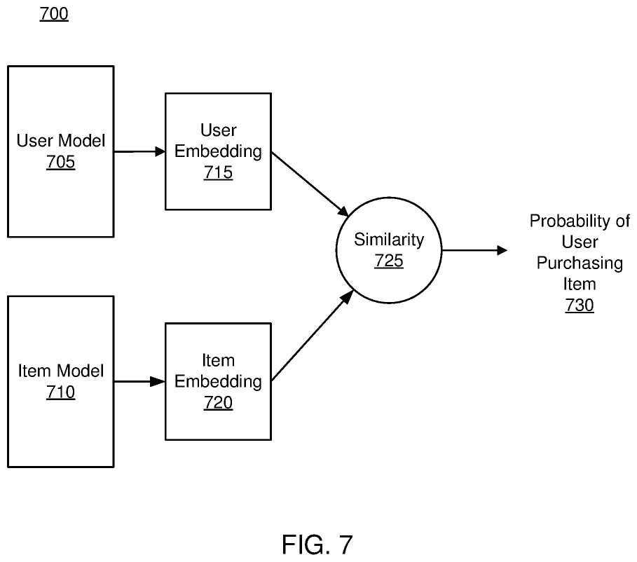

In various embodiments, the order fulfillment engine 206 generates and maintains an item graph, further described below in conjunction with FIGS. 6 and 7. The item graph identifies connections between pairs of items and attributes of items and between pairs of attributes of items. A connection between an item and an attribute indicates that the item has the attribute to which the item is connected. As further described below in conjunction with FIG. 7, the attributes of an item may be specified by information describing the product from a warehouse 110 providing the item or determined by the order fulfillment engine 206 based on information about the item received from the warehouse 110. A connection between an attribute and an additional attribute indicates that the attribute and the additional attribute have both occurred in one or more previously received orders for items. For example, the attribute is connected to the additional attribute if a previously received order included an item having the attribute and having another item having the additional attribute. Similarly, the attribute is connected to the additional attribute if a previously received order included an item having both the attribute and having the other attribute. As further described below in conjunction with FIG. 6, the order fulfillment engine 206 uses the item graph to generate search results of items in response to a search query received from a user 104, allowing the order fulfillment engine 206 to leverage information about different attributes and items to increase a likelihood of identifying items that at least partially match the search query for inclusion in an order.

### Machine Learning Models

The online concierge system 102 further includes a machine-learned item availability model 216, a modeling engine 218, and training datasets 220. The modeling engine 218 uses the training datasets 220 to generate the machine-learned item availability model 216. The machine-learned item availability model 216 can learn from the training datasets 220, rather than follow only explicitly programmed instructions. The inventory management engine 202, order fulfillment engine 206, and/or shopper management engine 210 can use the machine-learned item availability model 216 to determine a probability that an item is available at a warehouse 110. The machine-learned item availability model 216 may be used to predict item availability for items being displayed to or selected by a user or included in received delivery orders. A single machine-learned item availability model 216 is used to predict the availability of any number of items.

The machine-learned item availability model 216 can be configured to receive as inputs information about an item, the warehouse for picking the item, and the time for picking the item. The machine-learned item availability model 216 may be adapted to receive any information that the modeling engine 218 identifies as indicators of item availability. At minimum, the machine-learned item availability model 216 receives information about an item-warehouse pair, such as an item in a delivery order and a warehouse at which the order could be fulfilled. Items stored in the inventory database 204 may be identified by item identifiers. As described above, various characteristics, some of which are specific to the warehouse (e.g., a time that the item was last found in the warehouse, a time that the item was last not found in the warehouse, the rate at which the item is found, the popularity of the item) may be stored for each item in the inventory database 204. Similarly, each warehouse may be identified by a warehouse identifier and stored in a warehouse database along with information about the warehouse. A particular item at a particular warehouse may be identified using an item identifier and a warehouse identifier. In other embodiments, the item identifier refers to a particular item at a particular warehouse, so that the same item at two different warehouses is associated with two different identifiers. For convenience, both of these options to identify an item at a warehouse are referred to herein as an “item-warehouse pair.” Based on the identifier(s), the online concierge system 102 can extract information about the item and/or warehouse from the inventory database 204 and/or warehouse database and provide this extracted information as inputs to the item availability model 216.

The machine-learned item availability model 216 contains a set of functions generated by the modeling engine 218 from the training datasets 220 that relate the item, warehouse, and timing information, and/or any other relevant inputs, to the probability that the item is available at a warehouse. Thus, for a given item-warehouse pair, the machine-learned item availability model 216 outputs a probability that the item is available at the warehouse. The machine-learned item availability model 216 constructs the relationship between the input item-warehouse pair, timing, and/or any other inputs and the availability probability (also referred to as “availability”) that is generic enough to apply to any number of different item-warehouse pairs. In some embodiments, the probability output by the machine-learned item availability model 216 includes a confidence score. The confidence score may be the error or uncertainty score of the output availability probability and may be calculated using any standard statistical error measurement. In some examples, the confidence score is based in part on whether the item-warehouse pair availability prediction was accurate for previous delivery orders (e.g., if the item was predicted to be available at the warehouse and not found by the shopper, or predicted to be unavailable but found by the shopper). In some examples, the confidence score is based in part on the age of the data for the item, e.g., if availability information has been received within the past hour, or the past day. The set of functions of the item availability model 216 may be updated and adapted following retraining with new training datasets 220. The machine-learned item availability model 216 may be any machine learning model, such as a neural network, boosted tree, gradient boosted tree or random forest model. In some examples, the machine-learned item availability model 216 is generated from XGBoost algorithm.

The item probability generated by the machine-learned item availability model 216 may be used to determine instructions delivered to the user 104 and/or shopper 108, as described in further detail below.

The training datasets 220 relate a variety of different factors to known item availabilities from the outcomes of previous delivery orders (e.g. if an item was previously found or previously unavailable). The training datasets 220 include the items included in previous delivery orders, whether the items in the previous delivery orders were picked, warehouses associated with the previous delivery orders, and a variety of characteristics associated with each of the items (which may be obtained from the inventory database 204). Each piece of data in the training datasets 220 includes the outcome of a previous delivery order (e.g., if the item was picked or not). The item characteristics may be determined by the machine-learned item availability model 216 to be statistically significant factors predictive of the item's availability. For different items, the item characteristics that are predictors of availability may be different. For example, an item type factor might be the best predictor of availability for dairy items, whereas a time of day may be the best predictive factor of availability for vegetables. For each item, the machine-learned item availability model 216 may weight these factors differently, where the weights are a result of a “learning” or training process on the training datasets 220. The training datasets 220 are very large datasets taken across a wide cross section of warehouses, shoppers, items, warehouses, delivery orders, times and item characteristics. The training datasets 220 are large enough to provide a mapping from an item in an order to a probability that the item is available at a warehouse. In addition to previous delivery orders, the training datasets 220 may be supplemented by inventory information provided by the inventory management engine 202. In some examples, the training datasets 220 are historic delivery order information used to train the machine-learned item availability model 216, whereas the inventory information stored in the inventory database 204 include factors input into the machine-learned item availability model 216 to determine an item availability for an item in a newly received delivery order. In some examples, the modeling engine 218 may evaluate the training datasets 220 to compare a single item's availability across multiple warehouses to determine if an item is chronically unavailable. This may indicate that an item is no longer manufactured. The modeling engine 218 may query a warehouse 110 through the inventory management engine 202 for updated item information on these identified items.

Additionally, the modeling engine 218 maintains a purchase model, further described below in conjunction with FIGS. 5-7. The purchase model includes a user model and an item model that generate an embedding for a user and an embedding for an item, respectively. The user model generates the embedding for the user based on prior purchases by the user, preferences of the user, and any other suitable characteristics of the user. The item model generate the embedding for the item based on different words or phrases received by the online concierge system 102 as terms from users in interactions where the user selected the item, one or more categories associated with the item, popularity of the item at a warehouse 110, or any other suitable attributes of an item. From an embedding for the user and an embedding for an item, the purchase model determines a probability of the user purchasing the item, as further described below in conjunction with FIGS. 5 and 6. In various embodiments, the embedding for a user and the embedding for an item have an equal number of dimensions, and the purchase model generates the probability of the user purchasing the item based on a dot product or other measure of similarity between the embedding for the user and the embedding for the item. As further described below in conjunction with FIG. 5, the modeling engine 218 trains the purchase model based on prior purchases by users, which may modify or update the user model or the item model.

### Machine Learning Factors

The training datasets 220 include a time associated with previous delivery orders. In some embodiments, the training datasets 220 include a time of day at which each previous delivery order was placed. Time of day may impact item availability, since during high-volume shopping times, items may become unavailable that are otherwise regularly stocked by warehouses. In addition, availability may be affected by restocking schedules, e.g., if a warehouse mainly restocks at night, item availability at the warehouse will tend to decrease over the course of the day. Additionally, or alternatively, the training datasets 220 include a day of the week previous delivery orders were placed. The day of the week may impact item availability, since popular shopping days may have reduced inventory of items or restocking shipments may be received on particular days. In some embodiments, training datasets 220 include a time interval since an item was previously picked in a previously delivery order. If an item has recently been picked at a warehouse, this may increase the probability that it is still available. If there has been a long time interval since an item has been picked, this may indicate that the probability that it is available for subsequent orders is low or uncertain. In some embodiments, training datasets 220 include a time interval since an item was not found in a previous delivery order. If there has been a short time interval since an item was not found, this may indicate that there is a low probability that the item is available in subsequent delivery orders. And conversely, if there is has been a long time interval since an item was not found, this may indicate that the item may have been restocked and is available for subsequent delivery orders. In some examples, training datasets 220 may also include a rate at which an item is typically found by a shopper at a warehouse, a number of days since inventory information about the item was last received from the inventory management engine 202, a number of times an item was not found in a previous week, or any number of additional rate or time information. The relationships between this time information and item availability are determined by the modeling engine 218 training a machine learning model with the training datasets 220, producing the machine-learned item availability model 216.

The training datasets 220 include item characteristics. In some examples, the item characteristics include a department associated with the item. For example, if the item is yogurt, it is associated with the dairy department. The department may be the bakery, beverage, nonfood and pharmacy, produce and floral, deli, prepared foods, meat, seafood, dairy, the meat department, or dairy department, or any other categorization of items used by the warehouse. The department associated with an item may affect item availability, since different departments have different item turnover rates and inventory levels. In some examples, the item characteristics include an aisle of the warehouse associated with the item. The aisle of the warehouse may affect item availability, since different aisles of a warehouse may be more frequently re-stocked than others. Additionally, or alternatively, the item characteristics include an item popularity score. The item popularity score for an item may be proportional to the number of delivery orders received that include the item. An alternative or additional item popularity score may be provided by a retailer through the inventory management engine 202. In some examples, the item characteristics include a product type associated with the item. For example, if the item is a particular brand of a product, then the product type will be a generic description of the product type, such as “milk” or “eggs.” The product type may affect the item availability, since certain product types may have a higher turnover and re-stocking rate than others or may have larger inventories in the warehouses. In some examples, the item characteristics may include a number of times a shopper was instructed to keep looking for the item after he or she was initially unable to find the item, a total number of delivery orders received for the item, whether or not the product is organic, vegan, gluten free, or any other characteristics associated with an item. The relationships between item characteristics and item availability are determined by the modeling engine 218 training a machine learning model with the training datasets 220, producing the machine-learned item availability model 216.

The training datasets 220 may include additional item characteristics that affect the item availability and can therefore be used to build the machine-learned item availability model 216 relating the delivery order for an item to its predicted availability. The training datasets 220 may be periodically updated with recent previous delivery orders. The training datasets 220 may be updated with item availability information provided directly from shoppers 108, as described in further detail with reference to FIG. 5. Following updating of the training datasets 220, a modeling engine 218 may retrain a model with the updated training datasets 220 and produce a new machine-learned item availability model 216.

### Customer Mobile Application

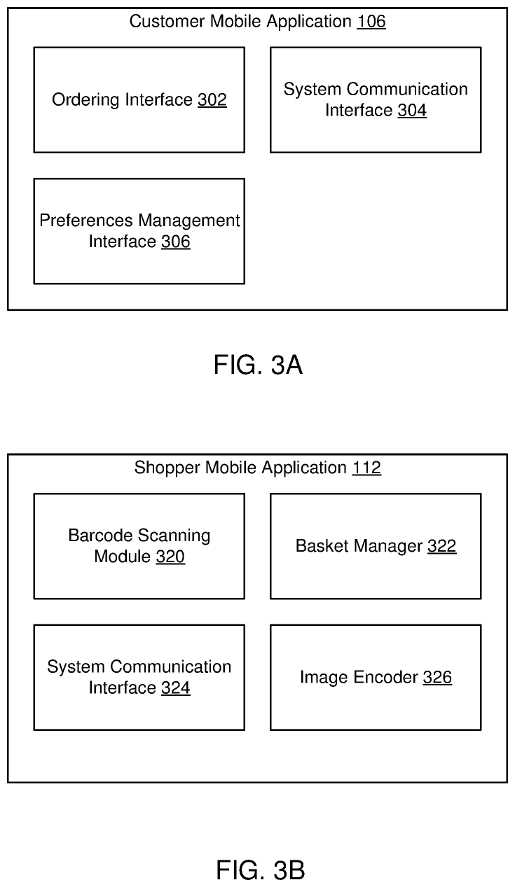

FIG. 3A is a diagram of the customer mobile application (CMA) 106, according to one embodiment. The CMA 106 includes an ordering interface 302, which provides an interactive interface with which the user 104 can browse through and select products and place an order. The CMA 106 also includes a system communication interface 304 which, among other functions, receives inventory information from the online shopping concierge system 102 and transmits order information to the system 102. The CMA 106 also includes a preferences management interface 306 which allows the user 104 to manage basic information associated with his/her account, such as his/her home address and payment instruments. The preferences management interface 306 may also allow the user to manage other details such as his/her favorite or preferred warehouses 110, preferred delivery times, special instructions for delivery, and so on.

### Shopper Mobile Application

FIG. 3B is a diagram of the shopper mobile application (SMA) 112, according to one embodiment. The SMA 112 includes a barcode scanning module 320 which allows a shopper 108 to scan an item at a warehouse 110 (such as a can of soup on the shelf at a grocery store). The barcode scanning module 320 may also include an interface which allows the shopper 108 to manually enter information describing an item (such as its serial number, SKU, quantity and/or weight) if a barcode is not available to be scanned. SMA 112 also includes a basket manager 322 which maintains a running record of items collected by the shopper 108 for purchase at a warehouse 110. This running record of items is commonly known as a “basket”. In one embodiment, the barcode scanning module 320 transmits information describing each item (such as its cost, quantity, weight, etc.) to the basket manager 322, which updates its basket accordingly. The SMA 112 also includes a system communication interface 324 which interacts with the online shopping concierge system 102. For example, the system communication interface 324 receives an order from the system 102 and transmits the contents of a basket of items to the system 102. The SMA 112 also includes an image encoder 326 which encodes the contents of a basket into an image. For example, the image encoder 326 may encode a basket of goods (with an identification of each item) into a QR code which can then be scanned by an employee of the warehouse 110 at check-out.

### Predicting Inventory Availability

As described with reference to FIG. 2, the machine-learned item availability model 216 of the online concierge system 102 can determine an availability of an item requested by the user 104. FIG. 4 is a flowchart illustrating a process 400 for predicting inventory availability, according to one embodiment. The online concierge system 102 receives 402 a delivery order that includes a set of items and a delivery location. The delivery location may be any location associated with a user, such as a user's home or office. The delivery location may be stored with the user location in the user database 214. Based on the delivery order, the online concierge system 102 identifies a warehouse 404 for picking the set of items in the delivery order based on the set of items and the delivery location. In some cases, the user specifies a particular warehouse or set of warehouses (e.g., a particular grocery store or chain of grocery stores) in the order. In other cases, the online concierge system 102 selects the warehouse based on the items and the delivery location. In some examples, there are a number of different possible warehouses that the set of items may be picked from. The warehouses may be identified by the order fulfillment engine 206 based on warehouses stored by the inventory management engine 202, and warehouses are identified with a suitable inventory and within a threshold distance of the delivery address. In some embodiments, a single delivery order can be split into multiple orders and picked at multiple warehouses, e.g., if the items cannot be fulfilled at a single warehouse. In this example, each possible warehouse is input into the machine-learned item availability model 216.

After the warehouses are identified, the online concierge system 102 retrieves 406 the machine-learned item availability model 216 that predicts a probability that an item is available at the warehouse. The items in the delivery order and the identified warehouses are input into the machine-learned item availability model 216. For example, the online concierge system 102 may input the item, warehouse, and timing characteristics for each item-warehouse pair into the machine-learned item availability model 216 to assess the availability of each item in the delivery order at each potential warehouse at a particular day and/or time. The machine-learned item availability model 216 predicts 408 the probability that one of the set of items in the delivery order is available at the warehouse. If a number of different warehouses are identified 404, then the machine-learned item availability model 216 predicts the item availability for each one. In some examples, the probability that an item is available includes a probability confidence score generated by the machine-learned item availability model 216.

The order fulfillment engine 206 uses the probability to generate 410 an instruction to a shopper. The order fulfillment engine 206 transmits the instruction to the shopper through the SMA 112 via the shopper management engine 210. The instruction is based on the predicted probability. In some examples, the shopper management engine 210 instructs the shopper to pick an item in the delivery order at a warehouse with the highest item availability score. For example, if a warehouse is more likely to have more items in the delivery order available than another warehouse, then the shopper management engine 210 instructs the shopper to pick the item at the warehouse with better availability. Other examples of the shopper management engine 210 instruction to the shopper are described in further detail with reference to FIGS. 5 and 6. In some other examples, the order fulfillment engine 206 sends a message and/or instruction to a user based on the probability predicted by the machine-learned item availability model 216.

### Training a Model to Determine a Probability of a User Purchasing an Item

FIG. 5 is a flowchart of a method for an online concierge system 102 training a model to determine a probability of a user purchasing an item based on an embedding for the user and an embedding for an item. In various embodiments, the method includes different or additional steps than those described in conjunction with FIG. 6. Further, in some embodiments, the steps of the method may be performed in different orders than the order described in conjunction with FIG. 6. The method described in conjunction with FIG. 6 may be carried out by the online concierge system 102 in various embodiments.

The modeling engine 218 maintains an item model configured to generate an embedding for an item, as well as a user model configured to generate an embedding for a user. As used herein, an “embedding” refers to descriptive data associated with an item or a user that indicates attributes or characteristics of the item or the user. Example attributes of an item identified by an embedding for an item include words or phrases provided by users to identify the item, one or more categories associated with the item, popularity of the item at a warehouse 110, or any other suitable attributes. Example characteristics of a user identified by an embedding for the user include products purchased by the user, categories associated with products purchased by a user, preferences of the user, restrictions of the user, warehouses 110 from which the user purchased items, and any other suitable characteristics. In some embodiments, an embedding for an item or for a user comprises a feature vector having multiple dimensions, with each dimension including a value describing one or more attributes of the item or characteristics of the user. The item model and the user model may be machine learning models in various embodiments. The modeling engine 218 separately maintains and updates the user model and the item model, so the user model and the item model are separate and discrete models. The user model and the item model may be any machine learning model, such as a neural network, boosted tree, gradient boosted tree or random forest model.

Additionally, the modeling engine 218 trains and maintains a purchase model that generates a probability of a user purchasing an item. The purchase model receives as input an embedding for an item generated by the item model and an embedding for a user generated by the user model and outputs a probability of the user purchasing the item.

To train the purchase model, the modeling engine 218 obtains 505 training datasets from stored transactions by a user with the online concierge system 102, such as data from the transaction records database 208. For example, the modeling engine 218 identifies purchases made by users within a specific time interval from the transaction records database 208. In some embodiments, the modeling engine 218 identifies purchases within a specific time interval and made by users who have previously made at least a threshold number of purchases via the online concierge system 102. A dataset retrieved from the transaction records database 208 includes information identifying a user making a purchase, items included in the purchase, a warehouse 110 from which the purchase was made, and temporal information (e.g., a date, a time) of the purchase.

From information in a training dataset identifying purchases, the modeling engine 218 selects a purchase and identifies a user who performed the purchase, items included in the purchase, and a warehouse 110 from which the items were purchased. The modeling engine 218 uses information about the selected purchase to generate 510 labeled data for training the purchase model. To generate 510 training data for the purchase model, the modeling engine 218 associates a label indicating an item was or was not purchased with a combination of attributes of the item and characteristics of the user. While this allows the modeling engine 218 to generate 510 labeled data for items that were purchased, to generate 510 labeled data for items that were not purchased in the training dataset, the modeling engine 218 samples items offered by the warehouse 110 from which items in an selected purchase were made that were not included in the selected purchase. In some embodiments, the modeling engine 218 retrieves an inventory of items offered by the warehouse 110 from which the selected purchase was made and randomly selects items offered by the warehouse 110 that were not included in the purchase and labels characteristics of the user and attributes of the randomly selected items as not purchased. Alternatively, the modeling engine 218 determines a popularity distribution of items previously purchased by users from the warehouse 110 from which the selected purchase was made and selects additional items that were not included in the selected purchase based on the popularity distribution of previously purchased items and labels combinations of attributes of the selected additional item and characteristics of the user as not purchased. When generating 510 labeled data, the modeling engine 218 generates a specified ratio of items labeled as purchased to items labeled as not purchased in some embodiments. For example, the labeled data includes a ratio of three items labeled as not purchased to one item labeled as purchased, although the modeling engine 218 may use different ratios in different embodiments.

Additionally, the modeling engine 218 identifies users who made the purchases and retrieves characteristics of the identified users. For an identified user, the modeling engine 218 identifies an item embedding for each item included in the purchase, an embedding corresponding to search terms the online concierge system 102 received from the user, preferences of the user, a length of time the user has used the online concierge system 102, information describing warehouses 110 from which the user previously made purchases, and may identify other information maintained for the user or for purchases made by the user via the online concierge system 102. In some embodiments, the modeling engine 218 additionally modeling engine 218 identifies embeddings corresponding to words or phrases the online concierge system 102 received from the user when the order was identifying items for the purchase. In some embodiments, for the identified user, the modeling engine 218 retrieves additional purchases previously made by the user from the transaction records database 208 and averages embeddings for items included in purchase previously made by the user, resulting in an embedding representing a purchase history of the user. Hence, the training data includes an embedding for an item, an embedding for a user, and a label indicating whether the item was purchased or was not purchased by the user.

The modeling engine 218 applies 515 the purchase model to the labeled training data, generating a probability of a user purchasing an item based on the embedding for the user from the user model and the embedding for the item from the item model. The modeling engine 218 compares 520 the generated probability of the user purchasing the item to the label applied to the combination of the embedding of the user and the embedding of the item. If the comparison indicates the probability generated by the purchase model differs from the label applied to the combination of the embedding for the user and the embedding of the item (e.g., the generated probability is below a threshold for purchasing the item when the label indicates the item was purchased or the generated probability is above a threshold for purchasing the item when the label indicates the item was not purchased), the modeling engine 218 modifies one or more parameters of the purchase model using any suitable supervised learning method. When updating parameters of the purchase model, the modeling engine 218 may modify one or more parameters of the user model or of the item model. The modeling engine 218 may iteratively modify the purchase model a specified number of times or until one or more criteria are satisfied using any suitable supervised learning method.

### Clustering Items for Recommendation to Users of an Online Concierge System

FIG. 6 is a flowchart of one embodiment of a method for recommending items to a user of an online concierge system 102 accounting for the user's probability of purchasing items. In various embodiments, the method includes different or additional steps than those described in conjunction with FIG. 6. Further, in some embodiments, the steps of the method may be performed in different orders than the order described in conjunction with FIG. 6. The method described in conjunction with FIG. 6 may be carried out by the online concierge system 102 in various embodiments.

The online concierge system 102 obtains 605 an inventory of items offered by one or more warehouses 110. In some embodiments, the online concierge system 102 obtains 605 an inventory from each warehouse 110, with an inventory from a warehouse identifying items offered by the warehouse 110. The inventory includes different entries, with each entry including information identifying an item (e.g., an item identifier, an item name) and one or more attributes of the item. Example attributes of an item include: one or more keywords, a brand offering the item, a manufacturer of the item, a type of the item, a price of the item, a quantity of the item, a size of the item and any other suitable information. Additionally, one or more attributes of an item may be specified by the online concierge system 102 for the item and included in the entry for the item in the inventory. Example attributes specified by the online concierge system 102 for an item include: a category for the item, one or more sub-categories for the item, and any other suitable information for the item.

From the information about various items in the inventory and information stored by the online concierge system 102 describing prior interactions by users of the online concierge system 102 selecting items, the online concierge system 102 generates 610 an embedding for each item. As further described above in conjunction with FIG. 5, the online concierge system 102 generates 610 the embedding for an item by applying an item model to attributes of the item. In some embodiments, the embedding for an item includes dimensions corresponding to different words or phrases received by the online concierge system 102 as terms from users in interactions where the user selected the item. Each dimension may include a value corresponding to a frequency with which the word or phrase corresponding to the dimension was received by the online concierge system 102 in interactions where a user selected the item. The online concierge system 102 maintains a stored vocabulary of words corresponding to dimensions of an embedding in various embodiments. One or more of the dimensions of the embedding correspond to categories associated with the item by the online concierge system 102, such as a department within a warehouse 110 including an item. When determining values of dimensions of embeddings for an item, the online concierge system 102 may evaluate interactions in which items were selected by users that occurred within a specified time interval (e.g., within 180 days of a current date). Alternatively or additionally, the online concierge system 102 orders items by dates when a user purchased or selected the items and generates 610 embeddings for items having at least a threshold position in the ordering, allowing generation of the embeddings for more recently purchased or selected items. The online concierge system 102 may generate 610 embeddings for items at a periodic interval, such as daily. In some embodiments, embeddings for items are generated 610 at different intervals for different warehouses 110.

Additionally, the online concierge system 102 generates 615 one or more collections of items offered by a warehouse 110. In some embodiments, the online concierge system 102 selects items offered by the warehouse 110 that have one or more common attributes for the collection. For example, a collection includes items offered by the warehouse 110 that are each associated with a common category by the online concierge system 102. As another example, a collection includes one or more items each associated with a common keyword by the online concierge system 102 or by the warehouse 110. In other embodiments, the online concierge system 102 generates 615 a collection based on embeddings for items offered by the warehouse 110. For example, the online concierge system 102 generates 615 a collection by clustering items offered by the warehouse 110 based on the embeddings for the items. In one embodiment, K-means clustering is used to cluster items offered by the warehouse 110 based on embeddings for the various items. Using K-means clustering causes an item to be clustered based on the distance of each dimension of an embedding for the item to a mean value associated with a dimension across all embeddings. For example, items having a value associated with a dimension that is within a specified distance to a mean value associated with the dimension are included in a cluster. The online concierge system 102 generates 615 a collection as including items in a cluster. However, in other embodiments, the online concierge system 102 may use any suitable method or methods to generate clusters of items based on their corresponding embeddings, with the clusters of items specifying collections of items.

In some embodiments, the online concierge system 102 leverages stored information about prior purchases by users to generate 615 a cluster. For example, the online concierge system 102 retrieves information describing purchases by one or more users and identifies items that co-occur in at least a threshold number or at least a threshold percentage of the prior purchases, the identified items are included in a cluster by the online concierge system. In some embodiments, the online concierge system 102 identifies items that co-occurred in prior purchases from a specific user or that co-occurred in prior purchases from users having one or more common characteristics. Additionally, the online concierge system 102 may identify prior purchases occurring within a specific time interval to identify items co-occurring in orders for inclusion in a cluster.

Using the embeddings for various items in a collection, the online concierge system 102 generates 620 a collection embedding for the collection. For example, a collection embedding is generated 620 for each cluster generated 615 by the online concierge system 102 based on the embeddings corresponding to each item in a collection. In some embodiments, the collection embedding is generated 620 by averaging values of dimensions of embeddings for items included in the collection. The online concierge system 102 may weight one or more dimensions of embeddings based on any suitable criteria and generate 620 the collection embedding based on the weighted values of dimensions of items in the collection. In some embodiments, the online concierge system 102 generates 620, or updates, the collection embedding at a periodic interval, and may update the collection embedding when an embedding for one or more items in the collection is generated 610 or is modified. The online concierge system 102 stores an identifier of a collection of items along with identifiers of items in the collection and the collection embedding generated 620 for the collection.

The online concierge system 102 identifies a user of the online concierge system 102 and generates 625 an embedding for the user by applying a user model to characteristics of the user, as further described in conjunction with FIG. 5. For example, the online concierge system 102 identifies a user from whom a request for one or more items was received and generates 625 the embedding for the user. To generate 625 the embedding for the user, the online concierge system 102 identifies items selected or purchased by the user and retrieves embeddings for the identified items. In some embodiments, the online concierge system 102 identifies items that the user purchased within a particular time interval (e.g., within 180 days of a current date), retrieves embeddings for the identified items, and generates 625 an embedding for the user with different dimensions corresponding to different products and values of the dimensions based on frequencies with which the user purchased products corresponding to the dimensions. In various embodiments, the online concierge system 102 averages values of the dimensions based on a number of purchases by the user and generates 625 the embedding for the user from the average values of the dimensions. Additionally, one or more dimensions of the embedding for the user correspond to characteristics of the user maintained by the online concierge system 102. For example, dimensions of the embedding for the user correspond to one or more dietary preferences or restrictions of the user, frequency of purchases from the warehouse 110 by the user, and any other suitable information maintained by the online concierge system 102.

The online concierge system 102 determines a score for each of one or more items by comparing the embedding for the user to embeddings for each of the one or more items. In various embodiments, the online concierge system 102 determines the scores by applying 630 a trained purchase model to the embedding for the user and to embeddings for one or more items. The probability of the user purchasing an item from the embedding of the user and the embedding of the item is the score for the item in such embodiments. Training of the purchase model is further described above in conjunction with FIG. 5. From an input of the embedding for the user and an embedding for an item, the trained purchase model outputs a probability of the user purchasing the item. The embedding for the user from the user model and embeddings for the items from the item model have an equal number of dimensions in various embodiments, with the trained purchase model determining the probability of the user purchasing an item based on a dot product of the embedding for the user and the embedding for the item. In various embodiments, the probability of the user purchasing in item is directly related to the dot product of the embedding for the user and the embedding for the item. Training of the purchase model is further described above in conjunction with FIG. 5. In other embodiments, the online concierge system 102 generates a score for an item based on any suitable comparison of the embedding for the user and the embedding for the item (e.g., dot product, cosine similarity, Euclidian distance, etc.).

FIG. 7 shows a process flow diagram of one embodiment of a purchase model 700. As shown in the example of FIG. 7, the purchase model 700 includes a user model 705 and an item model 710. As further described above in conjunction with FIG. 5, the user model 705 generates a user embedding 715 for a user based on characteristics of the user, while the item model 710 generates an item embedding 720 for an item based on attributes of the item. In the example shown by FIG. 7, the purchase model 700 determines a similarity 725 between the user embedding 715 and the item embedding 720 and determines a probability 730 of the user purchasing the item from the similarity 725. The similarity 725 determined as a dot product of the user embedding 715 and the item embedding 720 in some embodiments, while in other embodiments the purchase model 700 determines the similarity 725 between the user embedding 715 and the item embedding 720 using any suitable technique (e.g., cosine similarity, Euclidian distanced, etc.). As shown in FIG. 7, the user model 705 and the item model 710 are discrete models separately maintained by the online concierge system 102 and used in the purchase model 700.

Referring back to FIG. 6, the online concierge system 102 also determines a score for the collection by comparing the embedding for the user and the collection embeddings. In some embodiments, the online concierge system 102 determines the score for the collection by applying 630 the trained purchase model to the collection embedding and the embedding for the user. From the collection embedding and the embedding for the user, the trained purchase model outputs a probability of the user purchasing one or more items in the collection. The score for the collection is the probability of the user purchasing one or more items in the collection in such embodiments. In other embodiments, the online concierge system 102 generates a score for an item based on any suitable comparison of the embedding for the user and the embedding for the item (e.g., dot product, cosine similarity, Euclidian distance, etc.). As the collection includes one or more items, application of the trained purchase model to the collection embedding and the embedding for the user allows the online concierge system 102 to determine a probability of the user purchasing one or more items within the collection, enabling the online concierge system 102 to more efficiently determine if items in the collection are likely to be of interest to the user.

When the online concierge system 102 receives 635 a request for content from the user, the online concierge system 102 generates an interface displaying various items based on scores of the different items. As described above, in various embodiments, the scores for different items are the probabilities of the user purchasing different items determined from application of the trained model to the embedding for the user and embeddings for various items. Additionally, the interface includes information identifying one or more collections based on the scores for the one or more collections. As described above, in some embodiments, the scores for collections are probabilities of the user purchasing one or more items in a collection from application of the trained model to the embedding for the user and to collection embeddings for one or more collections. The interface displays information identifying items and one or more collections in an order based on the corresponding scores of the items and scores of the one or more collections (e.g., the probabilities of the user purchasing items or purchasing an item from a collection). For example, the online concierge system 102 ranks items and one more collections based on the scores of the items and the scores of the collections, with items or collections having higher scores having higher positions in the ranking. The online concierge system 102 orders the items and the one or more collections based on the ranking and displays the items and the one or more collections in the interface according to the order. For example, the interface displays items or collections with higher positions in the ranking in more prominent locations in the interface. The online concierge system 102 transmits 645 the interface to a client device of the user for display, such as for display via the customer mobile application 106 executing on the client device.

In some embodiments, the online concierge system 102 determines scores for multiple collections based on comparisons between collection embeddings for the collections and the embedding for the user. For example, the online concierge system 102 applies the trained purchase model to collection embeddings for multiple collections generated by the online concierge system 102 and to the embedding for the user and uses the probabilities output by the trained purchased model as the scores. Based on the scores from the comparisons, the online concierge system 102 ranks the collections so collections having higher scores have higher positions in the ranking (e.g., collections with higher probabilities have higher positions in the ranking). The online concierge system 102 identifies a set of collections from the ranking, such as collections having at least a threshold position in the ranking. For each identified collection, the online concierge system 102 determines scores for different items in the collection and ranks items within the collection based on the scores for the different items. For example, the online concierge system 102 applies the trained purchase model to items included in the collection, generating probabilities of the user purchasing different items in the collection, and determines an item ranking of items within the collection based on the generated probabilities. The online concierge system 102 orders items within the collection based on the item ranking. The interface generated by the online concierge system 102 displays identifiers of at least the set of collections in a first direction in an order based on their ranking. For each displayed collection, the interface displays items within a displayed collection in a second direction that is perpendicular to the first direction in an order based on the item ranking. In an example, the interface displays identifiers of at least the set of collections vertically in an order based on the ranking of collections and displays items within a collection in a horizontal row proximate to an identifier of the collection in an order based on the item ranking. This allows the interface to organize and display collections, as well as items within different collections, in orders that account for probabilities of the user purchasing an item from different collections and probabilities of the user purchasing different items within a collection.

### Additional Considerations

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium, which include any type of tangible media suitable for storing electronic instructions and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
obtaining, at an online concierge system, an inventory of items offered by one or more warehouses, the inventory identifying a warehouse offering an item and attributes of the item;
generating, by the online concierge system, an embedding for each item by applying an item model to attributes of the item from the obtained inventory and to prior interactions by users of the online concierge system selecting items offered by at least one warehouse;
generating, by the online concierge system, a collection of items offered by the warehouse;
generating, by the online concierge system, a collection embedding for the collection of items based on embeddings of items included in the collection;
generating, by the online concierge system, an embedding for a user of the online concierge system by applying a user model to characteristics of the user and to items the user previously purchased via the online concierge system, the user model separate from the item model;
determining a score for one or more items by comparing the embedding of the user to an embedding for the item;
determining a score for the collection by comparing the embedding for the user to the collection embedding;
receiving, at the online concierge system, a request from the user for content; and
transmitting an interface from the online concierge system to a client device of the user in response to the request, the interface including one or more items and the collection in an order based on the determined scores.

2. The method of claim 1, wherein generating, by the online concierge system, the collection of items offered by the warehouse:
selecting items offered by the warehouse having one or more common attributes.

3. The method of claim 2, wherein a common attribute comprises a category associated with the items by the online concierge system.

4. The method of claim 2, wherein a common attribute comprises a keyword associated with the items by the online concierge system.

5. The method of claim 1, wherein generating, by the online concierge system, the collection of items offered by the warehouse comprises:
generating one or more clusters of items offered by the warehouse based on the embeddings for the items, each cluster including items having a value for a dimension within a threshold distance of a mean value for the dimension; and
selecting a cluster of items as the collection of items.

6. The method of claim 1, wherein determining the score for one or more items by comparing the embedding of the user to the embedding for the item comprises:
applying, by the online concierge system, a trained purchase model to the embedding for the user and to embeddings for one or more items, the trained purchase model outputting a probability of the user purchasing the item from the embedding for the user and the embedding for the item.

7. The method of claim 6, wherein determining the score for the collection by comparing the embedding for the user to the collection embedding comprises:
applying, by the online concierge system, the trained purchase model to the collection embedding for the collection of items and to the embedding for the user, the trained purchase model outputting a probability of the user purchasing one or more items included in the collection from the embedding for the user and the collection embedding.

8. The method of claim 7, wherein embeddings for items and the embedding for the user have an equal number of dimensions.

9. The method of claim 8, wherein the trained purchase model determines the probability of the user purchasing the item based on a dot product of the embedding for the user and the embedding for the item.

10. The method of claim 9, wherein the probability of the user purchasing the item is directly related to the dot product of the embedding for the user and the embedding for the item.

11. The method of claim 9, wherein the trained purchase model determines the probability of the user purchasing one or more items included in the collection based on a dot product of the embedding for the user and the collection embedding.

12. The method of claim 1, wherein transmitting the interface from the online concierge system to the client device of the user in response to the request comprises:
generating a plurality of collections, each collection including one or more items offered by the warehouse;
generating the collection embedding for each collection of the plurality of collections;
determining scores for each collection by comparing the user embedding to each collection embedding;
determining, by the online concierge system, a score for each item in each of at least a set of the collections by comparing the user embedding to embeddings for each item in a collection of the set of the collections;
generating the interface displaying identifiers of each of at least the set of collections ordered by corresponding scores for the collections of the set and, for each collection of the set, displaying items included in the collection of the set in an order based on the scores for items in the collection of the set; and
transmitting the interface to the client device.

13. A computer program product comprising a non-transitory computer readable storage medium having instructions encoded thereon that, when executed by a processor, cause the processor to:
obtain, at an online concierge system, an inventory of items offered by one or more warehouses, the inventory identifying a warehouse offering an item and attributes of the item;
generate, by the online concierge system, an embedding for each item by applying an item model to attributes of the item from the obtained inventory and to prior interactions by users of the online concierge system selecting items offered by at least one warehouse;
generate, by the online concierge system, a collection of items offered by the warehouse;
generate, by the online concierge system, a collection embedding for the collection of items based on embeddings of items included in the collection;
generate, by the online concierge system, an embedding for a user of the online concierge system by applying a user model to characteristics of the user and to items the user previously purchased via the online concierge system, the user model separate from the item model;
determine a score for one or more items by comparing the embedding of the user to an embedding for the item;
determine a score for the collection by comparing the embedding for the user to the collection embedding;
receive, at the online concierge system, a request from the user for content; and
transmit an interface from the online concierge system to a client device of the user in response to the request, the interface including one or more items and the collection in an order based on the determined scores.

14. The computer program product of claim 13, wherein generate, by the online concierge system, the collection of items offered by the warehouse comprises:
select items offered by the warehouse having one or more common attributes.

15. The computer program product of claim 14, wherein a common attribute comprises a category associated with the items by the online concierge system.

16. The computer program product of claim 14, wherein a common attribute comprises a keyword associated with the items by the online concierge system.

17. The computer program product of claim 13, wherein generate, by the online concierge system, the collection of items offered by the warehouse comprises:
generate one or more clusters of items offered by the warehouse based on the embeddings for the items, each cluster including items having a value for a dimension within a threshold distance of a mean value for the dimension; and
select a cluster of items as the collection of items.

18. The computer program product of claim 13, wherein determine the score for one or more items by comparing the embedding of the user to the embedding for the item comprises:
apply, by the online concierge system, a trained purchase model to the embedding for the user and to embeddings for one or more items, the trained purchase model outputting a probability of the user purchasing the item from the embedding for the user and the embedding for the item.

19. The computer program product of claim 18, wherein determine the score for the collection by comparing the embedding for the user to the collection embedding comprises:
apply, by the online concierge system, the trained purchase model to the collection embedding for the collection of items and to the embedding for the user, the trained purchase model outputting a probability of the user purchasing one or more items included in the collection from the embedding for the user and the collection embedding.

20. The computer program product of claim 19, wherein embeddings for items and the embedding for the user have an equal number of dimensions.

21. The computer program product of claim 18, wherein the trained purchase model determines the probability of the user purchasing the item based on a dot product of the embedding for the user and the embedding for the item.

22. The computer program product of claim 21, wherein the probability of the user purchasing the item is directly related to the dot product dot product of the embedding for the user and the embedding for the item.

23. The computer program product of claim 21, wherein the trained purchase model determines the probability of the user purchasing one or more items included in the collection based on a dot product of the embedding for the user and the collection embedding.

24. The computer program product of claim 13, wherein transmit the interface from the online concierge system to the client device of the user in response to the request comprises:
generate a plurality of collections, each collection including one or more items offered by the warehouse;
generate the collection embedding for each collection of the plurality of collections;
determine scores for each collection by comparing the user embedding to each collection embedding;
determine, by the online concierge system, a score for each item in each of at least a set of the collections by comparing the user embedding to embeddings for each item in a collection of the set of the collections;
generate the interface displaying identifiers of each of at least the set of collections ordered by corresponding scores for the collections of the set and, for each collection of the set, displaying items included in the collection of the set in an order based on the scores for items in the collection of the set; and
transmit the interface to the client device.
